(19) United States
(12) Patent Application Publication
(10) Pub. No.: US 2011/0141735 A1
(43) Pub. Date: Jun. 16, 2011

(54) ILLUMINATABLE DEVICE

(76) Inventor: Xavier Jablonski, Victoria (AU)

(21) Appl. No.: 13/060,041

(22) PCT Filed: Aug. 28, 2009
(86) PCT No.: PCT/AU09/01125

§ 371 Date: Feb. 21, 2011

(30) Foreign Application Priority Data
Aug. 28, 2008 (AU) 2008904440

(51) Int. Cl. F21V 7/00; F21S 4/00

(52) U.S. Cl. 362/235; 362/227

(57) ABSTRACT

An illuminatable device (1) comprising: a side emitting light guide (2); a first controller end (4) adjoining a first end of said light guide (2); and a second controller end (4) adjoining a second end of said light guide (2), wherein at least one said controller end (4) includes at least one power source (11) and at least one said controller end (4) includes at least one light source (10) for illuminating said light guide (2) to create a multidirectional light output.

### FIELD OF THE INVENTION

The present invention relates to illuminatable devices. It relates particularly though not exclusively to a portable illuminatable lighting device capable of signalling the position or location of a person or object in poorly lit environments and alerting others to the person(s) or object(s) presence.

### BACKGROUND TO THE INVENTION

Illuminatable beacons and safety devices used to signal a person or object's position to others in poorly lit environments are widely used in a variety of applications including boating and military use, etc. Traditionally these illuminatable devices have taken a variety of forms including ignitable flares, and powered illuminatable beacons such as illuminated LED light sources or incandescent bulbs.

One such particularly useful illuminatable safety device is a glow or light stick. A glow stick consists of a tube having a flexible outer tube and a brittle inner tube. A first liquid is stored within the inner tube and a second liquid between the inner and outer tubes. When the tubes are bent the inner tube breaks, thereby allowing the two liquids to mix and causing a chemical reaction that makes the stick produce a bright fluorescent glow. Once activated, the stick will remain illuminated for a period of time (usually less than ten hours) until it ceases to glow and is then disposed of. When illuminated, glow or light sticks provide a useful safety or emergency light source.

The above devices all have limitations. The LED light sources only provide a unidirectional light, the incandescent bulbs consume too much power for portable applications and the light sticks are limited to a single operation.

The object of this invention is to provide an illuminatable device that alleviates the above problems, or at least provides the public with a useful alternative.

### SUMMARY OF THE INVENTION

Therefore, in one form of the invention there is proposed an illuminatable device comprising: a side emitting light guide; a first controller end adjoining a first end of said light guide; and a second controller end adjoining a second end of said light guide, wherein at least one said controller end includes at least one power source and at least one said controller end includes at least one light source for illuminating said light guide to create a multi-directional light output.

Preferably, the device of the invention has a substantially linear form.

The controller ends may be powered by batteries and operate simultaneously to direct an intense focused beam of light via LEDs into opposing ends of the light guide which in turn distributes the opposing light beams to provide a multi-directional glow that is capable of being seen from a substantial distance.

In preference, a cable provides an electrical connection between the two controller ends. This allows the voltage and current of the power sources contained within each controller end to be combined for use at either controller end.

The cable may additionally provide a communication means between the controller ends, enabling the controller ends to operate in a master/slave configuration. The master controller may consist of a simple ON/OFF switch or a microprocessor circuit in which case the ON/OFF Switch can be used to select between operating modes. The slave controller end may also include a microprocessor circuit, or may just provide electrical connections to its power and light sources. Using the microprocessor allows individual control over each light source, giving control over the total light output via the number of light sources enabled. The microprocessor also provides temporal control of the light sources to produce, for example, a flashing sequence, greatly enhancing the visibility of the device.

In preference the light guide is to be constructed using an extrusion process, e.g. the extrusion of a rigid transparent polymer rod, and/or a flexible transparent polymer cord having side-emissive light guide properties. Furthermore, the polymer light guide may be extruded together with a second integral co-extrusion along the length of the light guide. This integral co-extrusion along the length of the polymer light guide may have a ‘C’ shaped profile channel. This co-extruded ‘C’ shaped channel may form a snap fitting channel along the length of the light guide configured to receive the cable that electrically connect the opposing controller ends therein. Having the cable encapsulated in this fashion avoids the cable from being loose and becoming separated from the light guide and thereby assists in the protection of the bridging cable.

The ‘C’ shaped - channel integrally formed along the length of the said light guide may be formed of a non-light transmitting material that differs to that of the light guide itself, thereby allowing the light guide to retain a substantially cylindrical form. This prevents light spill via the co-extruded channel and enables the light guide to perform more effectively as a transmitter and distributor of light by maintaining a substantially cylindrical shape throughout the light guide. The ‘C’ shaped channel may be made of a solid non-transparent colour, e.g. white. The ‘C’ shaped channel may be formed to create a substantial footprint at the point where it is integrally attached along the length of the light guide. The footprint of the ‘C’ shaped co-extruded channel being made of a reflective colour such as white creates a light reflective strip along the length of the light guide so that when viewed through the transparent light guide body, the reflective strip appears magnified in width. When viewing the reflective strip of the ‘C’ shaped channel footprint through the transparent light guide body whilst being illuminated by the opposing controller ends, the reflective strip reflects additional light outwards and away from the reflective strip thereby intensifying illumination of the light guide when viewed from this direction whilst still providing substantially multi-directional illumination when viewed from other directions, e.g. perpendicular to the reflective strip.

The reflective strip of the ‘C’ shaped co-extrusion footprint may coloured to match that of the wavelength of the light being transmitted through the integrally attached side-emitting light guide via the opposing controller ends, e.g. a red coloured reflective strip used in combination with a red wavelength of light being transmitted through the light guide may provide a suitably reflective surface. The C′ shaped co-extrusion may be a rigid or a flexible co-extrusion. Alternatively the device of the invention may be made using injection moulding processes, bearing in mind that in this case the length of the device will be pre-determined, whereas in a extruded version virtually infininte variability of the length of the device is possible.

Preferably, the device of the invention includes at least one attachment means.

In a preferred embodiment of the present invention the attachment means is designed so that when the illuminatable device is attached to an object or person, it may be done so that the reflective strip of the ‘C’ shaped—channel faces outwards thereby reflecting the intensified light output in a direction away from the object to which the device is attached. Meanwhile, the ‘C’ shaped channel itself along with the encapsulated cable faces inwards towards the object or person to which it is attached, thus ensuring maximum light output in an outward fashion away from the object or person to which the device is attached.

In one particular form of the present invention one of the two opposing controller ends will be a master and the opposing controller end will be a slave to the master.

Preferably said light sources operate under the control of one of said controller ends.

In preference, said controller ends are electrically connected via a cable. The cable allows power to be shared between the controller ends and provides a communication means between the controller ends. The communication means allows a first controller end to control the light sources at a second controller end.

Viewed from one aspect of the present invention there is provided an illuminatable device having a substantially linear form, the device including opposing controller ends, at least one of the opposing controller ends including at least one light source, and at least one of the opposing ends including at least one power source, a side emitting light guide extending between the opposing controller ends, wherein activating the at least one light source illuminates the light guide.

According to an embodiment of the present invention there is provided an illuminatable device having a substantially linear form, the device including electrical controllers at opposing ends, a side-emissive light guide extending between said opposing controller ends, an electrical cable extending between said opposing controller ends, at least one power source contained within each of said opposing controller ends and at least one light source contained within each of said opposing controller ends for illuminating said side-emissive light guide.

The terminal ends of the side emitting light guide extending between the opposing controller ends are coupled thereto. The ends of the light guide abut the light sources contained within the opposing controller ends. When illuminated, the light sources contained within the opposing controller ends illuminate the side-emitting light guide from each end causing the light guide to glow an multi-directional and side-emitting fashion along the entire length of the light guide thereby providing a light source that is capable of being viewed from a distance in many different directions.

The electrical cable extending between the opposing controller ends provides an electrical connection between the controller ends and carries power and signal from one controller end to the other. This allows the voltage and current of the power sources contained within the opposing controller ends to be combined.

The electrical connection between the opposing controller ends via the cable further enables the light sources contained within the opposing controller ends to be operated simultaneously, this is particularly advantageous as it allows the light sources to be pulsed or flashed simultaneously in an ON/OFF fashion to illuminate the side-emitting light guide thus causing the device to flash ON/OFF in an eye catching fashion to enhance visibility. Thus, it is possible for the device to emit maximum light output whilst operating a flashing sequence. This contrasts with a situation in which light sources are illuminated alternately wherein the light intensity is only half of the maximum output in a flashing sequence.

As well as having at least one power source and at least one light source in each of the controller ends of the device it may further include a printed circuit board (PCB) in at least one of the two controller ends.

The device may have a PCB inside at least one of the opposing controller ends, the PCB including recharging circuits to allow recharging of the device if the power source comprises rechargeable batteries. Recharging of the rechargeable batteries may be performed via an external battery charger being electrically coupled to the device, e.g. via a power jack or docking station.

In one particular form of the present invention one of the two opposing controller ends will be a master and the opposing controller end will be a slave to the master. The master controller may have a PCB with a microprocessor on the PCB to allow the storing of pre-programmed flashing sequences to control the light source in each of the opposing ends of the device. The master controller preferably has a button/switch which turns the device ON/OFF and also allows selection of different lighting programs. The slave controller may also have a PCB to allow easy mounting during mass production of battery connectors, light sources and bridging cable connections however in this embodiment, the slave controller will only function as determined by the master controller.

An alternative embodiment of the present invention provides an illuminatable device having a substantially linear form, the device including opposing electrical controller ends, a side-emissive light guide extending between said opposing controller ends, electrical cable extending between the opposing controller ends, at least one power source contained within each of the said opposing controller ends and at least one light source contained within one of the opposing controller ends for illuminating the side-emissive light guide.

In this alternative embodiment one of the two opposing controller ends will be a master having at least one light source and the other a slave to the master having no light source but containing at least one power source such as a battery. The master controller may have a PCB with a microprocessor to allow the storing of pre-programmed flashing sequences to control the light source(s) of the master controller or alternatively may simply turn ON or OFF. The master controller preferably has a button or switch which turns the illuminatable device ON/OFF whilst also allowing the selection of different lighting programs. The slave controller may have a PCB to allow easy mounting during mass production of battery connectors, and bridging cable connections however in this alternative embodiment the slave controller may serve only provide additional power to the master controller.

In an alternative embodiment the electrically connected opposing controller ends are equal to one another in function, that is, neither of the opposing controller ends acts as master or slave to the other. In this form of the invention, whilst a cable may still be electrically connecting the opposing controller ends this may serve only to share the voltage and current of the power source in the opposing controllers. In this alternative embodiment the illuminatable device may not have a microprocessor and may simply be turned ON or OFF.

In another alternative embodiment there is provided an illuminatable device having a substantially linear form, the device including opposing electrical controller ends, a side-emissive light guide extending between the opposing controller ends, at least one power source contained within each of the said opposing controller ends and at least one light source contained within each of the opposing controller ends for illuminating the said side-emissive light guide. Each end of the side emitting light guide extending between the opposing controller ends is coupled with one of the opposing controller ends, and in turn abuts the light source(s) contained within the opposing controller ends. In this particular embodiment there may be no electrical bridging cable present since each controller end has its own independent power source such as a battery and its own independent lighting source. Each of the opposing controller ends may include an independent microprocessor to control each opposing controller end in a pre-programmed fashion independently of the other. Alternatively each controller end simply turns ON or OFF the light source via an electrical switch. In this particular embodiment the opposing controller ends must be activated at the same time to ensure maximum illumination of the device via the side-emitting light guide.

In yet a further embodiment there is provided an illuminatable device having a substantially linear form, the device including opposing controller ends and a side-emissive light guide extending between the opposing controller ends. The first controller end comprises a power source, a light source and an attachment means. The second controller end consists of an attachment means and optionally includes a light reflecting means. The combination of the light source and the reflector serve to boost the light intensity of the device. The first controller end may include a microprocessor to control the light sourced in a pre-programmed fashion, alternatively the first controller end simply turns the light source ON or OFF via an electrical switch.

Furthermore, in any embodiment, suitable electronic circuitry may be contained within each of the opposing controller ends to allow the opposing controller ends to send and/or receive control signals wirelessly from one opposing controller to the other, inturn allowing the opposing controller ends to operate simultaneously.

An alternative embodiment of the present invention provides an illuminatable device having a substantially linear form, the device including opposing electrical controller ends, a side-emissive light guide extending between said opposing controller ends, an electrical cable extending between the opposing controller ends, at least one power source contained within one of the opposing controller ends and at least one light source contained within the other opposing controller end for illuminating the side-emissive light guide, where by the power source in one of the opposing controller ends powers the light source in the other opposing controller end.

In a preferred embodiment of the present invention the illuminatable device may have integral and or releasable attachment means to allow the device to be fastened to a person and or object. The attachment means may be located on at least one of the opposing controller ends and may take any suitable form, e.g. formed as a clip to allow the device to be fastened to fabrics such as a person's clothing. In another form, the attachment means takes the form of one or more integral or releasable flexible attachment straps or slings to allow the device to be fastened securely to a person's limb or an object such as a bicycle frame. In some forms of the invention, there may be interchangeable attachment means to allow selection of the most suitable design to meet the required situation, for example sling or suction cup as the case may be.

Alternatively, the attachment means may take the form of one or more integral or releasably attached suction cups to allow the device to be attached to a latent surface such as glass or a motorcycle helmet. By having two attachment means, preferably in opposing positions, the device is prevented from moving in relation to the device to which it is attached. Once a first end of the device has been attached to an object by a first attachment means, the flexible nature of the device allows the second attachment means to be easily manipulated and attached to the object. This is particularly useful when the attachment means is a clip being attached to fabric or a suction cup being attached to a curved surface.

The illuminatable device may be powered via a remote power source such as a mains power socket or a cigarette lighter socket provided in a vehicle. If required, a suitable power adaptor, such as a switch mode power adaptor or linear power adaptor may be used in conjunction with a suitable electrical conductor, e.g. a power lead to electrically connect the illuminatable device to the power supply. Alternatively, the illuminatable device may have suitable power adaptor circuitry on board, e.g. on the PCB inside at least one of the two opposing controller ends, thereby allowing a direct electrical connection to a remote power supply, such as a mains power socket without the use of an external power adaptor or suitable power adaptor circuitry on board the illuminatable device. In a further alternative embodiment of the invention, the control electronics and optionally any switching devices may be housed externally to the controller ends and externally to the device. In other combinations a power supply in the form of a battery may be located externally to the device, whilst the control mechanism remains located in the controller ends. The side emitting light guide may take any suitable form. It may comprise a length of transparent rod, e.g. a rigid transparent polymer rod and/or a flexible transparent polymer cord having side-emissive light guide properties. Typically it will comprise a light guide core and a core cladding and/or outer jacket. The light guide may be either rigid or flexible. The light guide may typically comprise a polymer core surrounded by a polymer cladding, the core and cladding being suitably transparent and/or translucent.

The opposing controller ends may each have more than one light source, e.g. two or more light sources in one or both of the opposing controller ends. The multiple light sources may emit different wavelengths of light whilst coupled to the same light guide end. For example, in a light guide ends having an outer diameter of 10 mm having two different light sources in the form of light emitting diodes (LEDs) each with a 5 mm outer diameter abutting the light guide ends. In this example, one of the two LEDs at each opposing end of the light guide may emit a red wavelength light visible to the human eye whist the other two LEDs may emit an infrared wavelength light invisible to the human eye. Moreover, one of the opposing pairs of LEDs may be controlled to illuminate in unison whist the other opposing LED pair remains OFF, thereby allowing the light guide to illuminate in different and or multiple wavelengths of light at different times. It is also possible to adjust brightness of the device by microprocessor or potentiometer

Alternatively, when using multiple light sources in opposing controller ends coupled to and abutting opposing ends of a single light guide extending between the opposing controller ends, the light sources may be such that they of the same wavelength e.g. the light guide ends having an outer diameter of 10 mm having two different light sources such as Light Emitting Diodes (LEDs) each with a 5 mm outer diameter abutting each of the opposing light guide ends. For example, both of the two LEDs at each of the opposing ends may emit the same red wavelength of light visible to the human eye. When activating the two LED pairs simultaneously it may provide an illuminatable device with a single light guide having an increased illumination output by having four LEDs illuminating the single light guide instead of only one or two. In this embodiment the illuminatabie device may be controlled to enable switching between different levels of output light intensity, e.g. the user may select between illuminating two, three, four or more light sources simultaneously to illuminate a single light guide depending on the required light output.

In a further alternative embodiment of the present invention the illuminatable device may have more than one light guide extending in parallel between opposing controller ends.

It should be noted that any one of the aspects mentioned above may include any of the features of any of the other aspects mentioned above and may include any of the features of any of the embodiments described below as appropriate.

### BRIEF DESCRIPTION OF THE DRAWINGS

The accompanying drawings, which are incorporated in and constitute a part of this specification, illustrate various implementations of the invention and, together with the description, serve to explain the advantages and principles of the invention. In the drawings:

FIG. 1 is a perspective view of an illuminatable device according to one embodiment of the present invention;

FIG. 2 is a side view of the illuminatable device of FIG. 1;

FIG. 3 is a bottom view of the illuminatabie device of FIG. 1;

FIG. 4 is a side view of a cross section of the illuminatable device of FIG. 1;

FIG. 5 is a bottom view of a partial cross sectional of the illuminatable device of FIG. 1;

FIG. 6 is a bottom view of a partial cross section of an illuminatable device according to an embodiment having two LEDs in each of the opposing controller ends;

FIG. 7 is a side view of a cross section of an illuminatable device according

FIG. 8 is a side view of a cross section of an illuminatable device according to yet another embodiment with two independent controller ends, having no cable connecting them;

FIG. 9 is a side view of a side-emissive light guide with an integral co-extruded ‘C’ shaped Channel having a cable snap-fitted inside;

FIG. 9A is an end view of a side-emissive light guide with an integral co-extruded ‘C’ shaped channel;

FIG. 9B is an end view of a side-emissive light guide with an integral co-extruded ‘C’ shaped channel, having a cable snap-fitted inside;

FIG. 9C is bottom view of a side-emissive light guide with an integral co-extruded ‘C’ shaped channel, having a cable snap-fitted inside;

FIG. 10A is a side view of an illuminatable device including pins to secure the controller ends to the light guide;

FIG. 10B is a cross section view through a controller end of the illuminatable device of FIG. 10A;

FIG. 11A is a side view of an illuminatable device including pins to secure the controller ends to the light guide and a cable extending between the two controller ends;

FIG. 11B is a cross section view through a controller end of the illuminatable device of FIG. 11A;

FIG. 12 is a side view of a cross section of an illuminatable device including rechargeable batteries and a mains power battery charger;

FIG. 13 is a side view of a cross section of a remotely powered illuminatable device including an integrally attached power lead with a car cigarette lighter power plug;

FIG. 14 is a side view of the illuminatable device of FIG. 1 fastened to a pipe via releasable attachment slings; and FIG. 15 is a side view of a person riding a bicycle using the illuminatable device of FIG. 1 fastened to a cyclists clothing and to a bicycle.

### DETAILED DESCRIPTION OF PREFERRED EMBODIMENT

The following detailed description of the invention refers to the accompanying drawings. Although the description includes exemplary embodiments, other embodiments are possible, and changes may be made to the embodiments described without departing from the spirit and scope of the invention. Wherever possible, the same reference numbers will be used throughout the drawings and the following description to refer to the same and like parts. Dimensions of certain parts shown in the drawings may have been modified and/or exaggerated for the purposes of clarity or illustration.

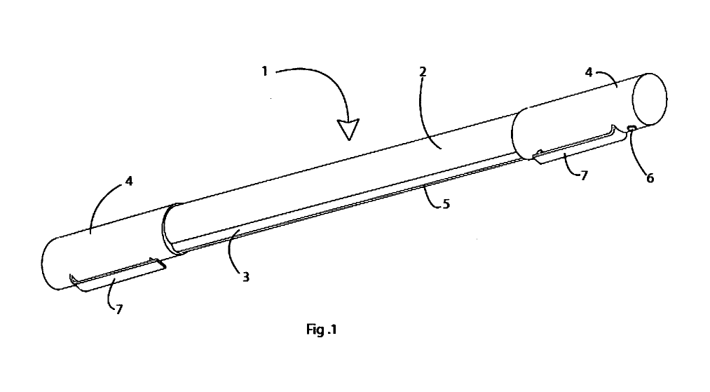

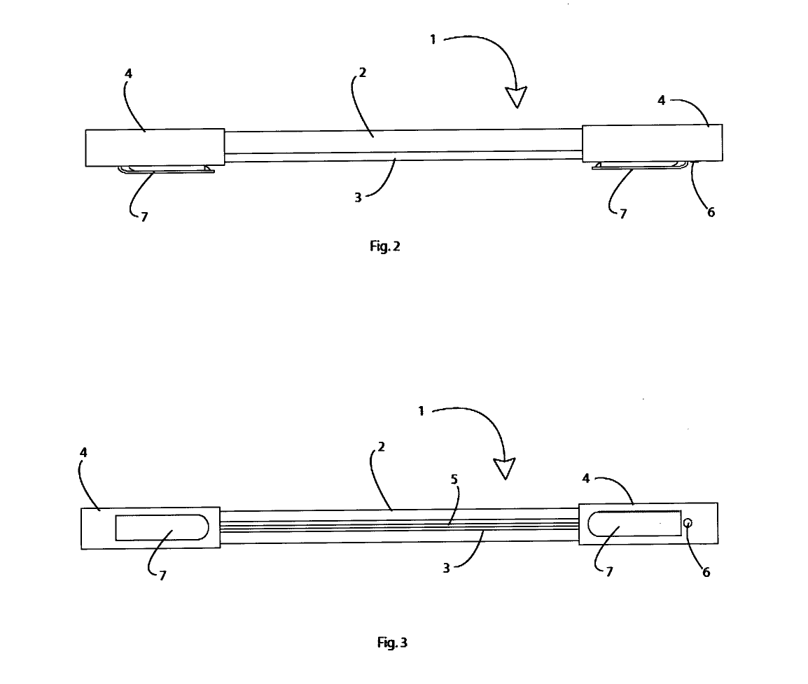

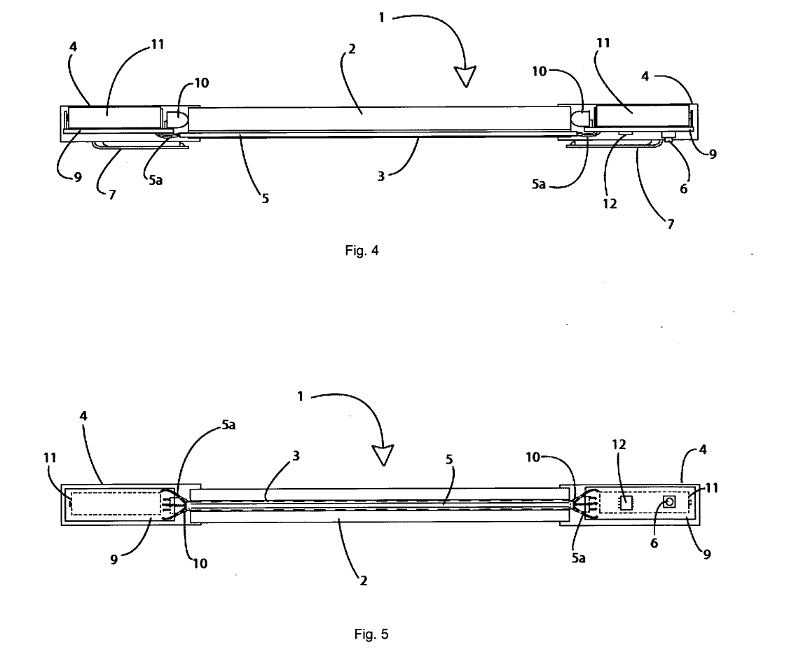

Referring firstly to FIGS. 1 to 5 , there is shown an illuminatable device 1 comprising a side-emitting light guide 2 and controller ends 4. The controller ends 4 are electrically connected by a cable 5 which is snap fitted into a co-extrusion 3 which is integrally attached along the length of the light guide 2. The controller ends 4 incorporate electronic components such as PCBs (Printed Circuit Boards) 9, MODE/ON/OFF switch 6, batteries 11, and microprocessor 12. The cable 5 incorporates individually insulated wires 5a, which allow for the sharing of both power and/or signals between the controller ends 4.

The controller ends 4 include MODE/ON/OFF switch 6 to allow the user to turn the illuminatable device 1 ON or OFF and to select between different operating modes controlled by the microprocessor 12. The operating modes include the number of LEDs 10 illuminated as well as temporal sequencing of the LEDs 10. The temporal sequencing could be used to make the device flash and thus increase its visibility or could be used to produce a signal such as an SOS for emergency situations. The batteries 11 provide power for the microprocessor and LEDs 10.

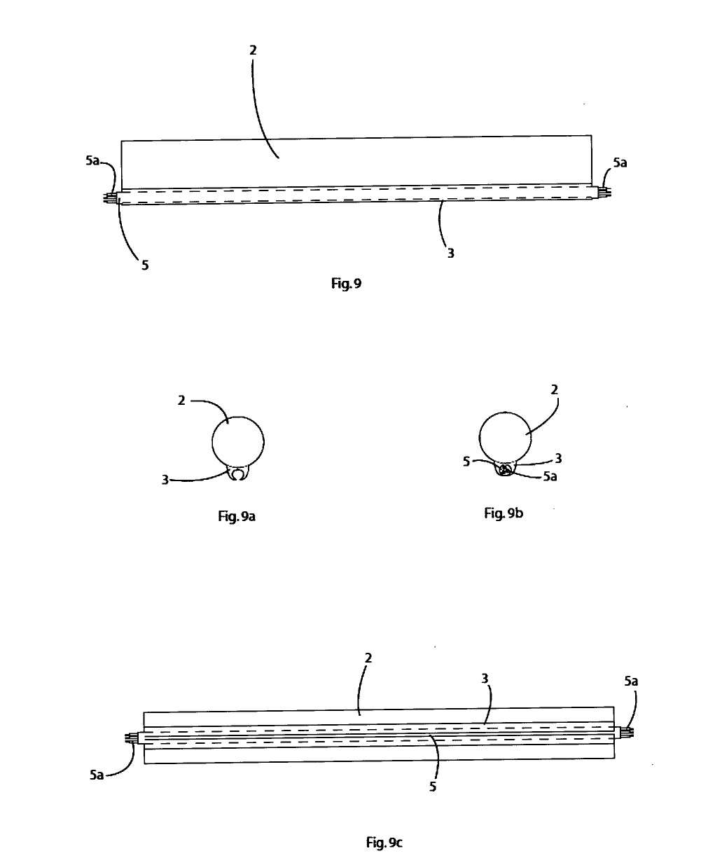

As shown in FIGS. 1-7, 9, 9A 9B, 9C, 11A, 11B, 12 and 14 the co-extrusion 3 has as a ‘C’ shaped profile to allow easy snap fitting of the cable 5 during production. The co-extrusion firmly holds the cable 5 without the need for adhesives. This configuration allows the cable 5 to slide back and forth within the co-extrusion as the illuminatable device 1 is bent or flexed in different directions during use. The co-extrusion 3 encapsulates and protects the cable 5 thereby preventing messy, loose and unsightly wires traversing from one controller end 4 to the other.

In addition to providing protection to the cable 5, the co-extrusion 3 acts as a light reflector to intensify the light output of the light guide 2 when viewed from a specific direction. The co-extrusion 3 is generally formed of a non-transparent material and has a substantial footprint where it is integrally attached to the light guide 2. This footprint is further magnified when viewed through the body of the light guide 2. When formed of a reflective material, the footprint of the co-extrusion 3 reflects light travelling through the light guide 2, producing an intensified light output from the light guide when viewed perpendicular to the reflective footprint of the co-extrusion.

The reflective footprint of the co-extrusion 3 is particularly useful when positioned such that it reflects intensified light in a direction where additional light is required. FIG. 15 illustrates a situation where the illuminatable device 1 is fastened to a cyclists body 18 and bicycle frame 19 to direct the intensified light output towards traffic approaching the cyclists from behind whilst still providing multi-directional illumination.

In a preferred embodiment the illuminatable device 1 includes an integral fastening clip 7 to allow easy fastening of the device to various objects. The fastening clip 7 can be located on each of the opposing controller ends 4. The clip 7 may take any suitable form and, as shown in FIG. 15, is specifically oriented on the control ends 4 so that when the illuminatable device 1 is fastened to an object such as a persons clothing, the maximum light output of the illuminatable device is emitted in a direction away from the wearer to maximise visibility in the desired direction.

In reference to FIGS. 14 and 15, in an alternative form the attachment means takes the form of an integral or releasable flexible attachment strap or sling 17. As shown in FIG. 14 the strap slides over the clip 7 and is then stretched, wrapped and fastened around an object such as a person's limb or a pole 20 or a bicycle frame 19 as shown in FIG. 15.

FIG. 6 shows an alternative embodiment of the present invention 1b wherein the controller ends 4 each have two independent LEDs 10 coupled to the light guide 2. The LEDs 10 may be of the same type or may emit light of different wavelengths to each other. When the LEDs 10 are of the same type, the microprocessor can be used to control the number of LED light sources that are illuminated and hence control the intensity of the light output from the device. Alternatively, when the LEDs emit light of different wavelengths to each other, the microprocessor can control the device to emit light at a first wavelength, or at a second wavelength or at both wavelengths simultaneously. Use of the different wavelengths would cause the light emitted from the device to appear as different colours. In a further embodiment, each controller end includes a first LED that produces light of a visible wavelength and a second LED that produces light of an infrared wavelength. Use of the infrared wavelength LEDs 10 provide the device with covert signalling capabilities that may be useful in security or military applications.

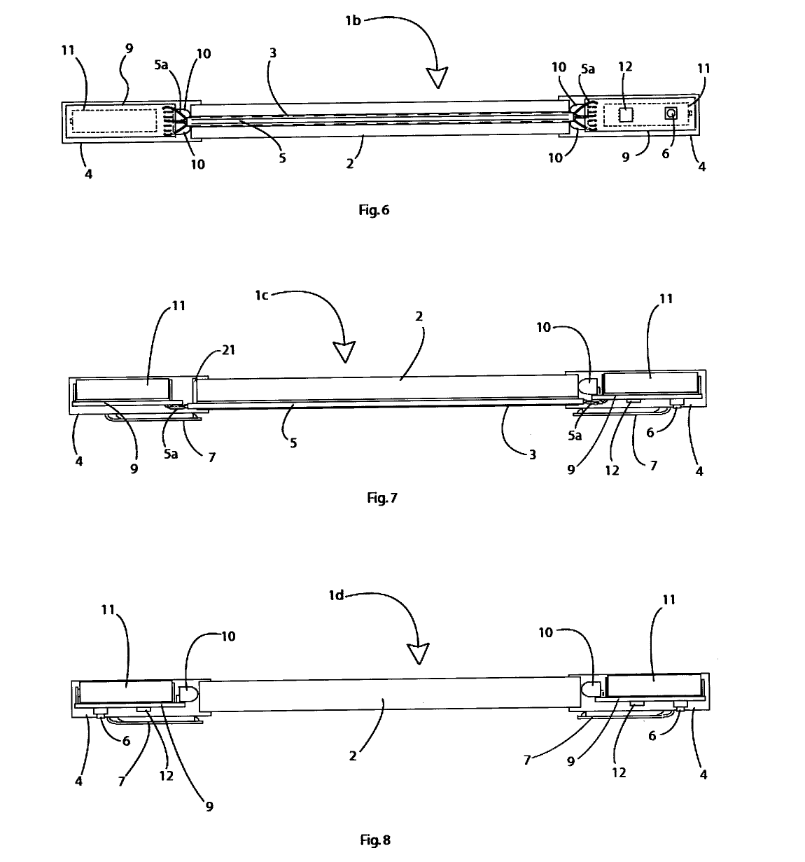

FIG. 7 shows an alternative embodiment of the present invention in which a first controller end has its LED light source replaced with a reflector 21. The reflector 21 is positioned at the end of the light guide 2 to reflect light emitted from the LED 10 of the second controller end back in to the light guide. Reflector 21 may have a gloss white or mirror reflector surface. In this embodiment (1c), the LED 10 of the second controller end may be of a particularly high powered variety and thus require the combined power of the batteries 11 from either controller end 4 to operate.

FIG. 8 shows an alternative embodiment 1d of the present invention in which no cable or other electrical connection is provided between the controller ends 4. Each of the controller ends 4 has its own power supply 11 and LED light source 10. The controller ends may have a microprocessor 12 to control the LED light source 10 or alternatively simply turn ON or OFF the LED 10 via a switch 6.

In a further embodiment, the two controller ends communicate with each other via a wireless means to coordinate operation of their LEDs 10. This communication could be implemented by an RF means, or by a light signalling means using the LEDs 10 in conjunction with light detectors.

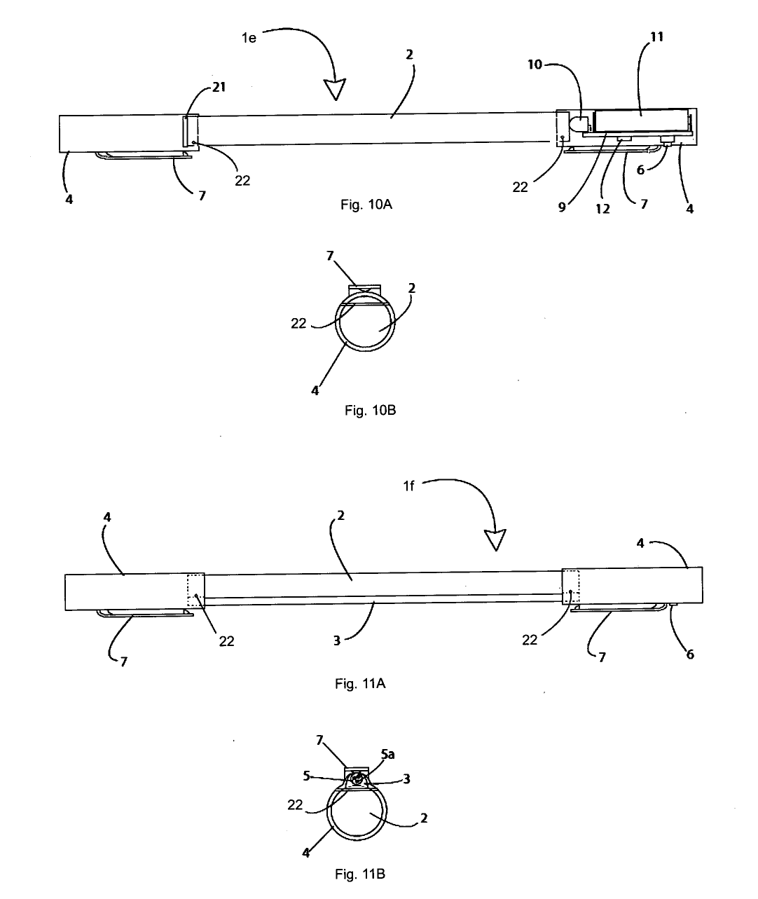

FIG. 10A shows, in side view an, illuminatable device le in accordance with the present invention. The device 1e includes a first controller end in which the LED light source replaced with a reflector 21. The reflector 21 is positioned at the end of the light guide 2 to reflect light emitted from the LED 10 of the second controller end back in to the light guide. Reflector 21 may have a gloss white or mirror reflector surface.

The device 1e further includes pins 22 used to secure the controller ends 4 to the light guide. The pins 22 provide a means for securely fastening the controller ends 4 to the light guide 2. In many cases the close fit between the controller ends 4 and the light guide 2 is sufficiently strong for them to be maintained in position. However, the pins 22 serve where additional robustness and strength is needed in the product. The pins 22 are positioned so as to be out of alignment with the LEDs 10 so that interference with the illumination is minimised.

FIG. 10B shows a cross sectional view through a controller end 4 of the illuminatable device, 1e, indicating in dotted lines the positioning of the pin 22 showing the off centre position.

Similarly, in FIG. 11A a side view of an illuminatable device 1f includes pins 22 to secure the controller ends 4 to the light guide 2. In this case a cable 5 extends between the two controller ends 4 The pins 22 are positioned to avoid the cable 5, as shown in the cross sectional view through a controller end of the device in FIG. 11B.

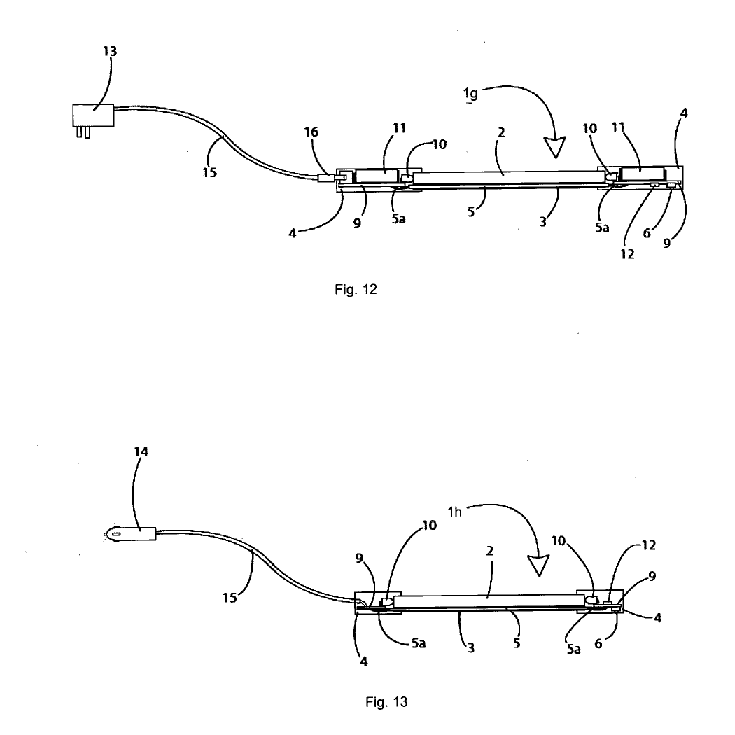

FIG. 12 shows variation 1g of the present invention having rechargeable batteries 11 capable of being recharged or powered via an external mains power adaptor or charger 13 via power lead 15 and power jack 16. Once charged, the illuminatable device le can have power jack 16 removed and the device becomes fully portable. Alternatively the illuminatable device le may remain connected and be powered via mains power indefinitely. Suitable recharging circuitry may be provided within the illuminatable device le or housed within the mains power adaptor/charger 13.

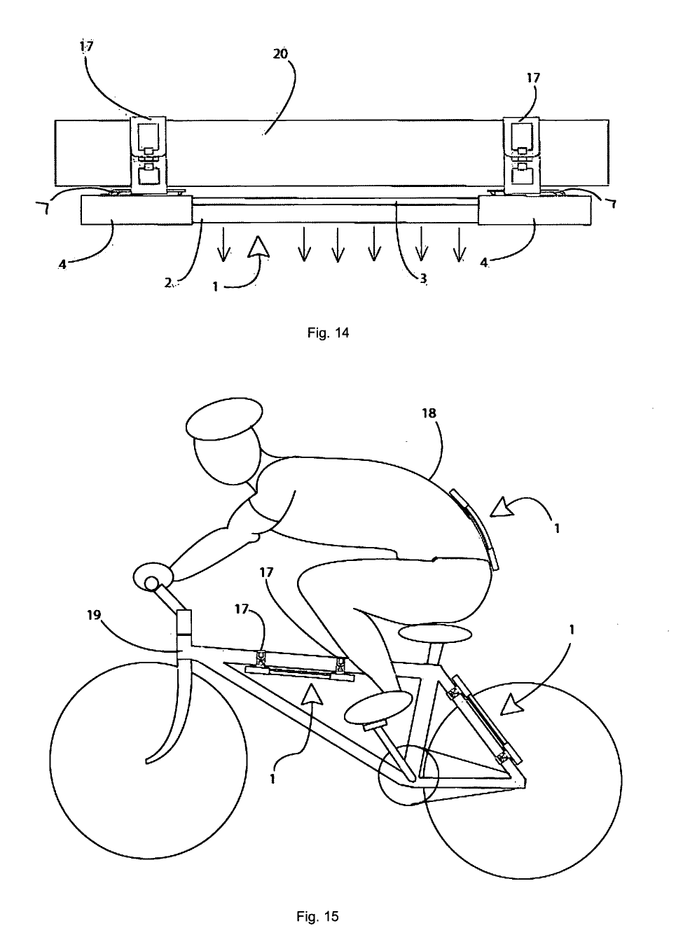

FIG. 13 shows variation 1h of the present invention having an integrally attached external power lead 15 capable of being plugged into a car cigarette lighter socket via plug 14. In this particular embodiment the device if may be used as a lamp to cast light inside a vehicle. A mains powered variation of illuminatable device 1f may also be made and used as a lamp. In this particular embodiment 1f a microprocessor 12 is present, however it may be constructed to simply turn ON or OFF via switch 6. Having access to mains power allows the use of much higher powered LEDs, or other high power light sources for example, halogen light sources thus making casting of light for use as a lamp possible.

It is to be understood that the illuminatable device may have a range of uses beyond those exemplified within the above descriptions such as a bicycle safety light, a marine/boating signal light, use as a portable camping light to cast light or for underwater diving applications and the like. It may also be used as a safety beacon in hazardous environments such as mining sites or for use to signal the location of road workers for personal safety etc. It may also be used in military applications where the illuminatable device may illuminate in a visible light and/or an invisible light such as infra red light.

In further embodiments the operation of the illuminatable device could be controlled automatically. For example, in marine safety applications the device could detect when it has been immersed in water and illuminate in response.

Further advantages and improvements may very well be made to the present invention without deviating from its scope. Although the invention has been shown and described in what is conceived to be the most practical and preferred embodiment, it is recognized that departures may be made therefrom within the scope and spirit of the invention, which is not to be limited to the details disclosed herein but is to be accorded the full scope of the claims so as to embrace any and all equivalent devices and apparatus.

In any claims that follow and in the summary of the invention, except where the context requires otherwise due to express language or necessary implication, the word “comprising” is used in the sense of “including”, i.e. the features specified may be associated with further features in various embodiments of the invention.

1. An illuminatable device characterized in that it comprises: a side emitting light guide; a first controller end adjoining a first end of said light guide; and a second controller end adjoining a second end of said light guide, wherein at least one said controller end includes at least one power source and at least one said controller end includes at least one light source for illuminating said light guide to create a multidirectional light output.

2. An illuminatable device according to claim 1, characterized in that said each controller end includes a light source and wherein each light source is operated independently.

3. An illuminatable device according to claim 1, characterized in that said device has a substantially linear form.

4. An illuminatable device according to claim 1, characterized in that said light sources operate under the control of one of said controller ends.

5. An illuminatable device according to claim 1, characterized in that said controller ends are electrically connected via a cable.

6. An illuminatable device according to claim 5, characterized in that said light guide includes a channel for receiving said cable.

7. An illuminatable device according to claim 6, characterized in that said channel has light reflecting properties.

8. An illuminatable device according to any one of claims 5-7, characterized in that said cable is free to slide in said channel.

9. An illuminatable device according to. any one of claims 6 through claim 8, characterized in that said light guide and said channel are manufactured using a co-extrusion process.

10. An illuminatable device according to any one of the preceding claims, characterized in that said light guide is flexible.

11. An illuminatable device according to any one of the preceding claims, characterized in that said device includes at least one attachment means.

12. An illuminatable device according to any one of the preceding claims, characterized in that said device includes two opposing attachment means.

13. An illuminatable device according to any one of the preceding claims, characterized in that said device includes interchangeable attachment means to permit selection of different methods of attachment a required.

14. An illuminatable device according to any one of the preceding claims, characterized in that said controller ends communicate via a wireless means.

15. An illuminatable device according to any one of the preceding claims, characterized in that said device includes a light source in one controller end thereof and a light reflector in an opposing controller end, said light reflector serving to reflect light from the light source back into the light guide.

16. An illuminatable device according to any one of the preceding claims, characterized in that said first light source produces light of a first wavelength and second said light source produces light of a second wavelength.

17. An illuminatable device according to claim 15, characterized in that said first said wavelength is in the visible region and said second said wavelength is in the infrared region.

18. An illuminatable device according to any one of the preceding claims, characterized that said device is waterproof.

19. An illuminatable device according to any one of the preceding claims, characterized that said light output is activated when said device is immersed in water.

20. An illuminatable device according to any one of the preceding claims, characterized in that said controller ends are powered via a rechargeable power supply.

21. An illuminatable device according to any one of the preceding claims, characterized in that said controller ends are powered via an external power supply.

22. An illuminatable device according to any one of the preceding claims, characterized in that said controller ends are secured to said light guide by means of pins passing through each controller end and the light guide.
